(19) United States
(12) Patent Application Publication
(10) Pub. No.: US 2018/0347530 A1
(43) Pub. Date: Dec. 6, 2018

(54) BRAKE RELEASE DETECTION SYSTEM FOR AUTOMATIC ENGINE RESTART

(71) Applicants: Truc Le, Rochester Hills, MI (US); Craig A Summers, Northville, MI (US); Simon Wong, Sterling Heights, MI (US)

(72) Inventors: Truc Le, Rochester Hills, MI (US); Craig A Summers, Northville, MI (US); Simon Wong, Sterling Heights, MI (US)

(21) Appl. No.: 15/611,341

(22) Filed: Jun. 1, 2017

(51) Int. Cl. F02N 11/08; B60T 17/22

(52) U.S. Cl. CPC F02N 11/084; B60T 17/22; F02N 2200/102; B60T 2270/88; F02N 2200/0807; B60T 2201/06

(57) ABSTRACT

An automatic engine stop-start system of a vehicle having an engine includes a controller in signal communication with the engine and configured to command automatically stopping and starting the vehicle engine, a first sensor in signal communication with the controller and configured to generate a first signal indicative of a grade of a road the vehicle is located on, and a master brake cylinder having a pressure sensor in signal communication with the controller, the pressure sensor configured to generate a pressure signal indicative of a master cylinder brake pressure. The controller is further configured to determine a pressure threshold based on the first signal and the pressure signal. When the pressure signal exceeds the pressure threshold, thereby indicating a driver is releasing a brake pedal of the vehicle, the controller commands automatically restarting the vehicle engine.

### FIELD

The present application relates generally to automatic stop-start engine systems and, more particularly, to a system and method for detecting a brake release to initiate automatic engine restart.

### BACKGROUND

Many modern vehicles are equipped with an automatic stop-start system that automatically shuts down and restarts the vehicle engine to reduce fuel consumption. For example, the vehicle engine may be automatically turned off when the vehicle comes to a stop at a traffic signal, and automatically started when the driver releases the brake pedal. Conventional systems include a brake pedal position switch that triggers the engine restart when the driver releases the brake pedal and the brake pedal reaches a top of its travel. However, such systems have a time delay between the driver's release of the brake pedal and the engine restart. Accordingly, while such conventional stop-start systems work well for their intended purpose, it is desirable to provide an automatic engine stop-start system with improved engine restart times.

### SUMMARY

In one exemplary aspect of the invention, an automatic engine stop-start system of a vehicle having an engine is provided. The system includes, in one exemplary implementation, a controller in signal communication with the engine and configured to command automatically stopping and starting the vehicle engine, a first sensor in signal communication with the controller and configured to generate a first signal indicative of a grade of a road the vehicle is located on, and a master brake cylinder having a pressure sensor in signal communication with the controller, the pressure sensor configured to generate a pressure signal indicative of a master cylinder brake pressure. The controller is further configured to determine a pressure threshold based on the first signal and the pressure signal. When the pressure signal exceeds the pressure threshold, thereby indicating a driver is releasing a brake pedal of the vehicle, the controller commands automatically restarting the vehicle engine.

In addition to the foregoing, the described system may include one or more of the following features: wherein the controller includes a first logic configured to check for a predetermined master cylinder brake pressure over a hill start assist brake pressure that will allow an engine auto-stop maneuver; wherein the first logic is programmed to receive the signal indicating the road grade, determine a brake pressure hysteresis calibration based on the signal indicating the road grade, and determine if the vehicle grade is greater than a predetermined grade; wherein the controller includes a second logic configured to check for a sufficient master brake cylinder brake pressure over a minimum brake pressure required with hysteresis; wherein the controller includes a third logic configured to monitor a master cylinder brake pressure gradient to allow automatic engine restart ability for calibratable gradient ranges; wherein the first sensor is an accelerometer; and wherein the pressure signal exceeding the pressure threshold indicates a decrease in the brake master cylinder pressure.

In another exemplary aspect of the invention, a method of operating a vehicle having an engine and an automatic stop-start engine system is provided. The method includes, in one exemplary implementation, receiving a first signal from a first sensor, the first signal indicative of a grade of the road the vehicle is located on, receiving a pressure signal from a brake master cylinder pressure sensor, the pressure signal indicative of a master cylinder brake pressure, determining a pressure threshold based on the received first signal and pressure signal, and automatically restarting the vehicle engine when the pressure signal exceeds the pressure threshold, thereby indicating that a driver of the vehicle is releasing a brake pedal of the vehicle.

In addition to the foregoing, the described method may include one or more of the following features: performing a first control logic to check for a predetermined master cylinder brake pressure over a hill start assist brake pressure that will allow the engine to perform an auto-stop maneuver; wherein performing the first control logic comprises receiving the signal indicating the road grade, determining a brake pressure hysteresis calibration based on the signal indicating the road grade, and determining if the vehicle grade is greater than a predetermined grade; performing a second control logic configured to check for a sufficient master brake cylinder pressure over a minimum break pressure required with hysteresis; performing a third control logic configured to monitor the master cylinder brake pressure gradient to allow an automatic engine restart ability for calibratable gradient ranges; and receiving the first signal from an accelerometer.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF DRAWINGS

FIG. 1 is a schematic illustration of a vehicle control system in accordance with the principles of the present application;

FIG. 2 is a flow diagram illustrating an example method of operating the vehicle control system shown in FIG. 1, in accordance with the principles of the present application;

FIG. 3 is a graph comparing brake release detection times of a prior art system with the current system shown in FIG. 1, in accordance with the principles of the present application;

FIG. 4 is a flow diagram illustrating an example method of calibrating signals of the system shown in FIG. 1, in accordance with the principles of the present application;

FIG. 5 is a flow diagram illustrating an example control logic for the system shown in FIG. 1, in accordance with the principles of the present application;

FIG. 6 is a flow diagram illustrating another example control logic for the system shown in FIG. 1, in accordance with the principles of the present application; and

FIG. 7 is a flow diagram illustrating yet another example control logic for the system shown in FIG. 1, in accordance with the principles of the present application.

### DESCRIPTION

Described herein are systems and methods for optimizing engine restart time to minimize automatic start delay on an automatic engine stop-start system. The system utilizes pressure sensor readings from a master brake cylinder in conjunction with a detected vehicle grade to subsequently determine a restart pressure threshold. The system is configured to automatically restart the vehicle engine when the restart pressure threshold is exceeded.

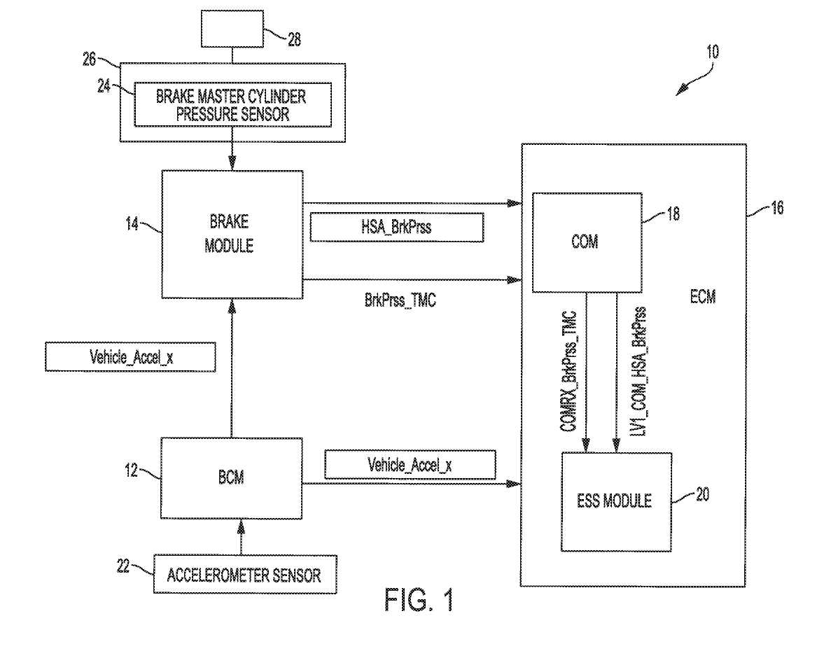

With initial reference to FIG. 1, an example schematic diagram of a vehicle control system is illustrated and generally identified at reference numeral 10. The vehicle control system 10 is equipped with an automatic stop-start system configured to automatically shut down and restart a vehicle engine (not shown). In the example embodiment, vehicle control system 10 generally includes a body control module (BCM) 12, a brake module 14, and a controller or engine control module (ECM) 16 having a communication controller or module (COM) 18 and an automatic engine stop-start system (ESS) controller or module 20.

As used herein, the term module or controller refers to an application specific integrated circuit (ASIC), an electronic circuit, a processor (shared, dedicated, or group) and memory that executes one or more software or firmware programs, a combinational logic circuit, and/or other suitable components that provide the described functionality.

In the illustrated embodiment, BCM 12 is in signal or electrical communication with an accelerometer sensor 22, the brake module 14, and the ECM 16. BCM 12 is generally configured to act as a gateway for information (e.g., longitudinal acceleration information) over the networking bus to the ECM 16. Accelerometer sensor 22 is configured to determine a road grade or vehicle pitch.

In the example embodiment, brake module 14 is in signal or electrical communication with a brake master cylinder pressure sensor 24, BCM 12, and ECM 16. The brake module 14 is generally configured to supply relevant brake pressure and switch information of the networking bus to the ECM 16. The brake master cylinder pressure sensor 24 is operably associated with a brake master cylinder 26, which is configured to supply pressurized hydraulic fluid to the brakes (not shown) of the vehicle. Brake master cylinder pressure sensor 24 is configured to detect a hydraulic pressure of the brake fluid in brake master cylinder 26 when a vehicle brake pedal 28 is pushed or applied. As such, force on brake pedal 28 transfers brake fluid to the vehicle brakes via brake master cylinder 26. The pressure sensor 24 measures fluid pressure in the brake master cylinder 26 and converts the pressure reading to a signal that is sent to brake module 14.

In the illustrated example, ECM 16 is in signal or electrical communication with BCM 12 and brake module 14. ECM 16 includes COM 18, which is configured to facilitate communication between brake module 14 and ESS module 20. The ESS module 20 is configured to selectively automatically shut off and restart the vehicle engine. Moreover, ESS module 20 is configured to automatically restart the vehicle engine with minimal delay based on one or more signals from accelerometer 22 and brake master cylinder pressure sensor 24, as described herein in more detail. Further, ECM 16 includes an algorithm or control software that enables vehicle control system 10 to determine if the vehicle engine should be automatically shut off, as well as if a driver is releasing the brake pedal, by monitoring the brake pedal pressure gradient rather than absolute pedal position, which enables faster detection and improved response time for automatically restarting the vehicle engine.

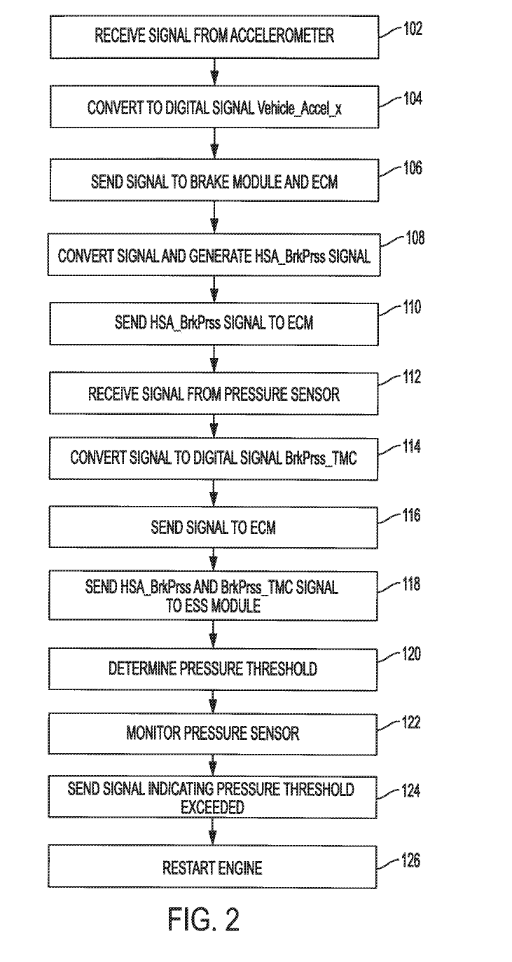

In one example operation 100 shown in FIG. 2, at step 102, BCM 12 receives a signal from accelerometer sensor 22. At step 104 BCM 12 converts the analog accelerometer signal from the accelerometer sensor 22 into a digital signal Vehicle_Accel_x′. At step 106, BCM 12 sends the digital accelerometer signal to brake module 14 and ECM 16. At step 108, brake module 14 converts the ‘Vehicle_Accel_x’ signal and generates a hill start assist (HSA) signal ‘HSA_BrkPrss’, which is indicative of the pressure required to keep the vehicle from rolling back on the grade the vehicle is presently on (e.g., a grade >5%).

In one configuration, ‘HSA_BrkPrss’ having a value greater than 1 indicates the brake pressure required to hold the vehicle on a current road grade that is greater than 5%. An ‘HSA_BrkPrss’ signal having a value equal to zero indicates the vehicle is on a current road grade less than 5%. An ‘HSA_BrkPrss’ signal having a value of 1 indicates the vehicle is not stopped. However, the system is not limited to a 5% grade and may have any predetermined road grade (e.g., 4%).

If the vehicle is on a current road grade greater than 5%, a lookup table is utilized to determine the pressure required to keep the vehicle from rolling back on the current road grade. For example, Table 1 below illustrates a table of exemplary ‘HSA_BrkPrss’ pressure values for a given road grade %. At step 110, brake module 14 sends the ‘HSA_BrkPrss’ signal to ECM 16 to indicate the pressure required to keep the vehicle from rolling backwards on the current road grade.

TABLE 1

| Grade % | ‘HSA_BrkPrss’ (Bar) |
|---|---|
| 0 | 0 |
| 5 | 12 |
| 6 | 14 |
| 7 | 16 |
| 8 | 20 |
| 9 | 25 |
| 10 | 30 |

At step 112, brake module 14 receives an analog signal from the brake master cylinder pressure sensor 24 indicating brake pressure applied by the driver. At step 114, brake module 14 converts the analog pressure signal to a digital brake master cylinder pressure signal ‘BrkPrss_TMC’. At step 116, brake module 14 sends the signal ‘BrkPrss_TMC’ to ECM 16. At step 118, the signals ‘HSA_BrkPrss’ and ‘BrkPrss_TMC’ are directed through COM 18 and subsequently sent to ESS module 20 as respective signals ‘LV1_COM_HSA_BrkPrss’ and ‘COMRX_BrkPrss_TMC’.

At step 120, a pressure threshold is determined and calibrated based on the signals ‘LV1_COM_HSA_BrkPrss’ and ‘COMRX_BrkPrss_TMC’. Accordingly, this pressure threshold is determined based on sensor readings or signals from accelerometer sensor 22 and brake master cylinder pressure sensor 24. The pressure threshold represents the pressure at the brake master cylinder 26 that indicates the driver is releasing the brake pedal to restart the engine. Accordingly, at step 122, brake module. 14 continuously monitors pressure readings at the brake master cylinder pressure sensor 24. When the pressure reading is less than or exceeds the predetermined threshold, at step 124, brake module sends a signal to the ECM 16 indicating the predetermined threshold has been exceeded (i.e., the driver is releasing the brake pedal). At step 126, ESS module 20 commands the vehicle engine to restart based on the signal indicating the predetermined threshold has been exceeded.

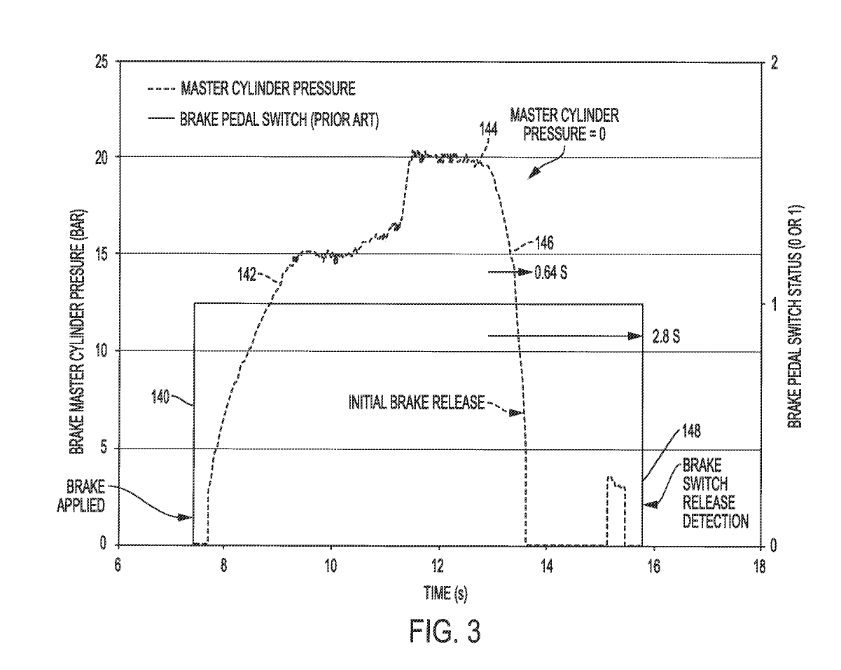

FIG. 3 illustrates a graph comparing example brake release detection times for a prior art brake pedal switch (line 140) and the current method described herein utilizing accelerometer sensor 22 and brake master cylinder pressure sensor 24 (line 142). As illustrated, the initial brake release is shown at a point 144. The presently described system 10 detects a brake release at a point 146; whereas the prior art brake pedal switch system results in a brake release detection at a point 148. Accordingly, system 10 detects a brake pedal release in a significantly shorter time than the prior art, thereby improving response time and enabling the vehicle engine to be restarted quicker

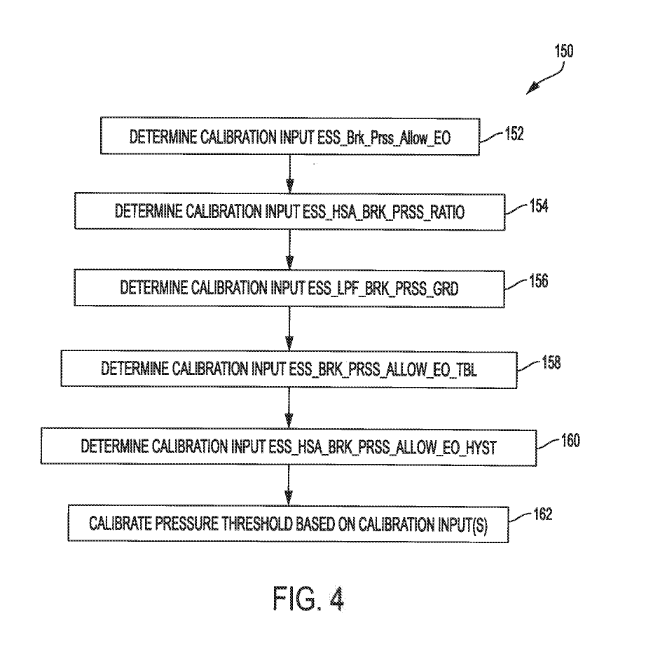

In one example implementation shown in FIG. 4, a method 150 of calibrating the signals ‘LV1_COM_HSA_BrkPrss’ and ‘COMRX_BrkPrss_TMC’ in step 120 is illustrated. At step 152, a calibration input ESS_BRK_PRSS_ALLOW_EO is determined by evaluating the brake pressure requirement to keep the vehicle from rolling back on a predetermined grade (e.g., 0 to <5%). Calibration input ESS_BRK_PRSS_ALLOW_EO provides an input indicating the minimum required brake pressure from EO to keep the vehicle from rolling back on the predetermined grade.

At step 154, a calibration input ESS_HSA_BRK_PRSS_RATIO is determined by evaluating different vehicle configurations on the grade (e.g., >5%) to develop a ratio margin. Calibration input ESS_HSA_BRK_PRSS_RATIO accounts for hill hold system variation and system age. Calibration input ESS_HSA_BRK_PRSS_RATIO may then be multiplied by the HAS brake pressure to calculate an ESS HSA pressure threshold, which is an adjustable calibration option to provide a more robust threshold.

At step 156, a calibration input ESS_LPF_BRK_PRSS_GRD is determined by evaluating the brake COMRX_BrkPrss_TMC signal to determine the appropriate filter out any minor pressure variation from the brake system. Calibration input ESS_LPF_BRK_PRSS_GRD provides an input indicating a low pass filter factor for brake pressure TMC is being filtered to assure accurate brake pressure gradient calculation.

At step 158, a calibration input ESS_BRK_PRSS_GRD_ALLOW_EO_TBL is determined by evaluating multiple scenarios when the driver releases the brake on the grade (e.g., >5%) to develop a gradient calibration. Calibration input ESS_BRK_PRSS_GRD_ALLOW_EO_TBL provides an input indicating a minimum required brake pressure gradient changes to indicate the driver releasing the brake.

At step 160, a calibration input ESS_{—} BRK_PRSS_ALLOW_EO_HYST is determined by evaluating the rate of brake pressure drop when the driver releases the brake at different initial brake pressure. Calibration input ESS_BRK_PRSS_ALLOW_EO_HYST provides an input indicating a hysteresis for HSA required brake pressure, which determines a threshold for a consistent engine restart.

At step 162, one or more calibration inputs from steps 152-160 are utilized to adjust or calibrate the pressure threshold determined in step 120.

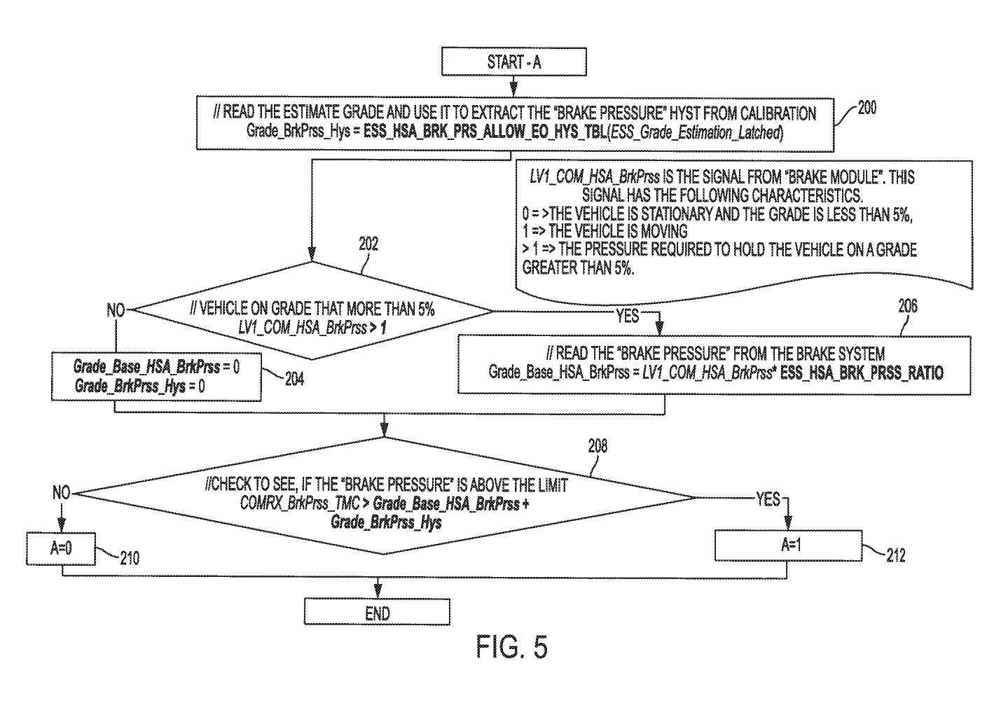

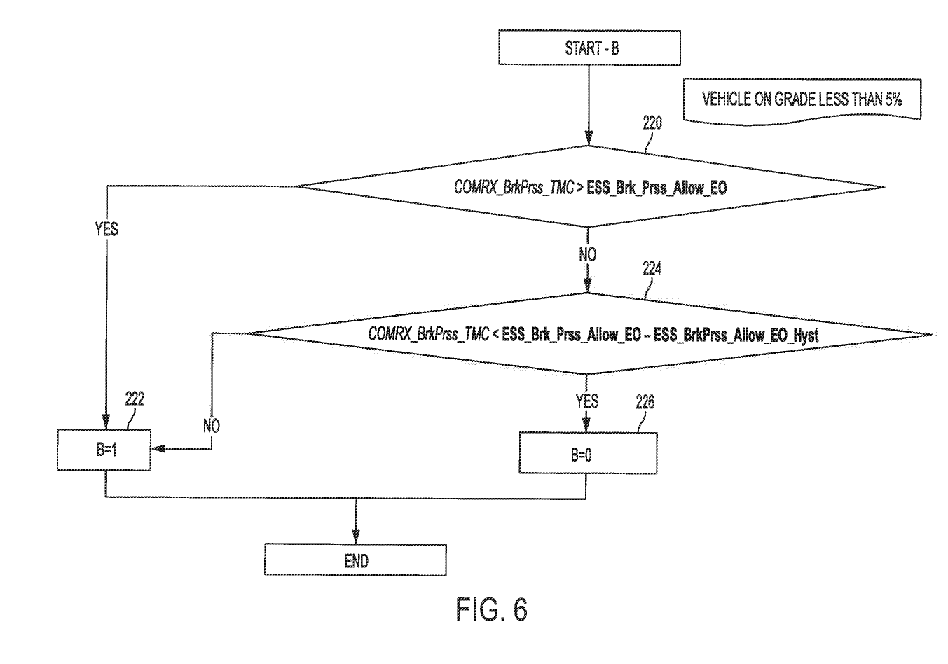

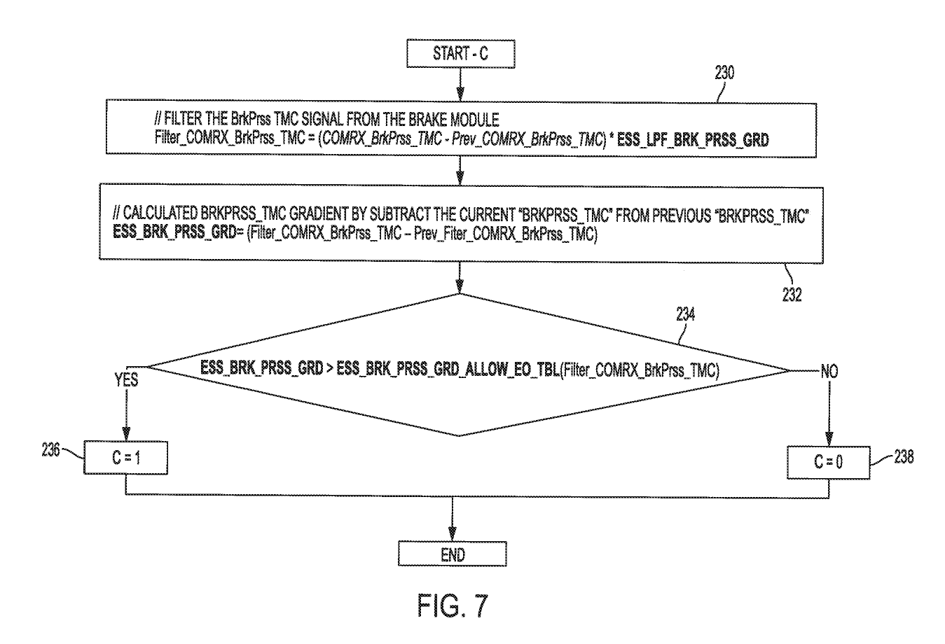

With further reference to FIGS. 5-7, another control strategy or algorithm for determining if the vehicle engine should be automatically stopped and/or restarted is illustrated. The control strategy includes a first control logic (A) including logic checks for sufficient master cylinder brake pressure over a hill start assist brake pressure to allow an engine auto-stop maneuver (FIG. 5), a second control logic (B) including logic checks for sufficient master cylinder brake pressure over a minimum brake pressure required with hysteresis (FIG. 6), and a third control logic (C) that monitors the master cylinder brake pressure gradient to allow automatic engine restart ability for calibratable gradient ranges (FIG. 7).

FIG. 5 illustrates the first control logic (A), which begins at step 200 where ECM 16 receives a signal indicating the estimated road grade and uses the received signal to determine a brake pressure hysteresis calibration (e.g., step 158). At step 202, ECM 16 determines if the vehicle grade is greater than a predetermined grade (e.g., 5%).

If no, at step 204, ECM 16 generates a signal Grade_Base_HSA_BrkPrss=0 and a signal Grade_BrkPrss_Hys=0, which indicate the vehicle is moving or if the vehicle is on a grade (e.g., <5%), and then sets the conditions to be true (bypass the condition check). If yes, at step 206, ECM 16 receives a brake pressure signal from pressure sensor 24 indicating the brake pressure at the brake master cylinder 26. At step 208, ECM 16 determines if the indicated brake pressure is above a predetermined limit LV1_{—} COM_{—} HSA_{—} Brkprss. If no, at step 210, ECM 16 sets a signal A=0. If yes, at step 212, ECM 16 sets a signal A=1.

FIG. 6 illustrates the second control logic (B) where the vehicle is on a grade less than the predetermined grade (e.g., 5%). The control logic begins at step 220 where ECM 16 determines if COMRX_BrkPrss_TMC is greater than ESS-Brk_Prss_Allow_EO. If yes, at step 222, ECM 16 sets a signal B=1. If no, at step 224, ECM 16 determines if COMRX_BrkPrss_TMC is less than the difference of ESS_Brk_Prss_Allow_EO and ESS_BrkPrss_Allow_EO_Hyst. If no, ECM 16 proceeds to step 222. If yes, at step 226, ECM 16 sets a signal B=0.

FIG. 7 illustrates the third control logic (C), which begins at step 230 where the signal ‘BrkPrss_TMC’ from brake module 14 is filtered to minimize brake pressure signal noise. At step 232, the signal ‘BrkPrss_TMC’ is determined by subtracting the current ‘BrkPrss_TMC’ from the previous ‘BrkPrss_TMC’. Such a function can be looped (e.g., every 10 ms) before the function to call the current value of the filter ‘BrkPrss_TMC’ is saved as a previous value when the next time the function executes the new ‘BrkPrss_TMC’ will be calculated and the ESS_BRK_PRSS_GRD is the difference between the current filter ‘BrkPrss_TMC’ and the previous saved filter ‘BrkPrss_TMC’. At step 234, ECM 16 determines if ESS_BRK_PRSS_GRD is greater than a calibrated gradient from the lookup calibration table ESS_BRK_PRS_GRD_ALLOW_EO_TBL (Filter_COMRX_BrkPrss_TMC). If yes, at step 236, ECM 16 sets a signal C=1. If no, at step 238, ECM 16 sets a signal C=0.

If all the logic conditions A, B, and C are true (=1), then the vehicle engine is able to be automatically shut off by ESS module 20. If any of logic conditions A, B, or C are not true (=0), the ESS module 20 will automatically restart the vehicle engine.

Accordingly, when the vehicle is stopped on a road grade that is less than the predetermined grade (e.g., 5%) and the driver steps on the brake, the vehicle engine is automatically shut off when: (i) A=1, e.g., when ‘COMRX_BrkPrss_TMC’ is greater than zero; (ii) B=1, e.g., when ‘COMRX_BrkPrss_TMC’ is greater than ‘ESS_Brk_Prss_Allow_EO’; and (iii) when C=1, e.g., when ‘ESS_BRK_PRSS_GRD’ gradient is greater than ESS_BRK_PRSS_ALLOW_EO_TBL(Filter_COMRX_BrkPrss_TMC).

When the driver releases the brake, the vehicle engine will be automatically turned on when: (i) A=0, e.g., when ‘COMRX_BrkPrss_TMC’ is equal to zero; (ii) B=0, e.g., when ‘COMRX_BRKPRSS_TMC’ is less than (‘ESS_Brk_Prss_Allow_EO’−ESS_Brk_Prss_Allow_EO_Hyst′); and (iii) C=0, e.g., when ‘ESS_BRK_PRSS_ GRD’ gradient is less than ‘ESS_BRK_PRSS_ALLOW_EO_TBL’ (Filter_COMRX_BrkPrss_TMC).

When the vehicle is stopped on a road grade that is greater than or equal to the predetermined grade (e.g., 5%) and the driver steps on the brake, the vehicle engine is automatically shut off when: A=1, e.g., when ‘COMRX_BrkPrss_TMC’ is greater than [(‘LV1_COM_HSA_BrkPrss’*‘ESS_HSA_BRK_PRSS_RATIO’) ‘ESS_HSA_BRK_PRSS_ALLOW_EO_HYST_TBL’(‘ESS_GRADE_ESTIMATION−LATCHED)]; B=1, e.g., when ‘COMRX_BrkPrss_TMC’ is greater than ESS_Brk_Prss_Allow_EO′; and C=1, e.g., when ‘ESS_BRK_PRSS_GRD’ gradient is greater than ‘ESS_BRK_PRSS_ALLOW_EO_TBL’(Filter_COMRX_BrkPrss_TMC).

When the driver releases the brake, the vehicle engine will be automatically turned on when: A=1, e.g., when ‘COMRX_BrkPrss_TMC’ is less than (‘LV1_COM_HSA_BrkPrss’*‘ESS_HSA_BRK_PRSS_RATIO’); B=0, e.g., when ‘COMRX_BRK_PRSS_TMC’ is less than (‘ESS_Brk_Prss_Allow_EO’−‘ESS-Brk_Prss_Allow_EO_Hyst’); and C=0, e.g., when ‘ESS_BRK_PRSS_GRD’ gradient is less than ‘ESS_BRK_PRSS_ALLOW_EO_TBL(Filter_COMRX_BrkPrss_TMC)’.

Accordingly, in the example implementation, system 10 establishes a pressure threshold for stopping the engine. The pressure threshold will vary dependent on road grade percent with additional hysteresis. The brake pressure is additionally filtered, for example, to filter out any sensor noise. The gradient calculation is based on the current and previous brake pressure filter signals, and the gradient threshold is based on how much the driver presses on the brake.

Described herein are systems and methods for improved brake release detection to enable improved response time for automatically restarting an auto stop-start engine. The system monitors a brake master cylinder pressure and road gradient rather than an absolute pedal position to enable the improved brake release detection.

It will be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An automatic engine stop-start system of a vehicle having an engine, comprising:
a controller in signal communication with the engine and configured to command automatically stopping and starting the vehicle engine;
a first sensor in signal communication with the controller and configured to generate a first signal indicative of a grade of a road the vehicle is located on; and
a master brake cylinder having a pressure sensor in signal communication with the controller, the pressure sensor configured to generate a pressure signal indicative of a master cylinder brake pressure,
wherein the controller is further configured to determine a pressure threshold based on the first signal and the pressure signal, and
wherein when the pressure signal exceeds the pressure threshold, thereby indicating a driver is releasing a brake pedal of the vehicle, the controller commands automatically restarting the vehicle engine.

2. The system of claim 1, wherein the controller includes a first control strategy configured to check for a predetermined master cylinder brake pressure over a hill start assist brake pressure that will allow an engine auto-stop maneuver.

3. The system of claim 2, wherein the controller with the first control strategy is configured to:
receive the signal indicating the road grade;
determine a brake pressure hysteresis calibration based on the signal indicating the road grade; and
determine if the vehicle grade is greater than a predetermined grade.

4. The system of claim 2, wherein the controller includes a second control strategy configured to check for a sufficient master brake cylinder brake pressure over a minimum brake pressure required with hysteresis.

5. The system of claim 4, wherein the controller includes a third control strategy configured to monitor a master cylinder brake pressure gradient to allow automatic engine restart ability for calibratable gradient ranges.

6. The system of claim 1, wherein the first sensor is an accelerometer.

7. The system of claim 1, wherein the pressure signal exceeding the pressure threshold indicates a decrease in the brake master cylinder pressure.

8. A method of operating a vehicle having an engine and an automatic stop-start engine system, the method comprising:
receiving, at a controller, a first signal from a first sensor, the first signal indicative of a grade of the road the vehicle is located on;
receiving, at the controller, a pressure signal from a brake master cylinder pressure sensor, the pressure signal indicative of a master cylinder brake pressure;
determining, by the controller, a pressure threshold based on the received first signal and pressure signal; and
automatically restarting the vehicle engine when the pressure signal exceeds the pressure threshold, thereby indicating that a driver of the vehicle is releasing a brake pedal of the vehicle.

9. The method of 8, further comprising the controller performing a first control strategy configured to check for a predetermined master cylinder brake pressure over a hill start assist brake pressure that will allow the engine to perform an auto-stop maneuver.

10. The method of claim 9, wherein the controller performing the first control strategy comprises:
receiving the signal indicating the road grade;
determining a brake pressure hysteresis calibration based on the signal indicating the road grade; and
determining if the vehicle grade is greater than a predetermined grade.

11. The method of claim 9, further comprising the controller performing a second control strategy configured to check for a sufficient master brake cylinder pressure over a minimum break pressure required with hysteresis.

12. The method of claim 11, further comprising the controller performing a third control strategy configured to monitor the master cylinder brake pressure gradient to allow an automatic engine restart ability for calibratable gradient ranges.

13. The method of claim 8, further comprising the controller receiving the first signal from an accelerometer.
